(19) United States
(12) Patent Application Publication
(10) Pub. No.: US 2018/0126402 A1
(43) Pub. Date: May 10, 2018

(54) SPRAYING APPARATUS AND CHEMICAL SOLUTION

(71) Applicant: MAINTECH CO., LTD., Tokyo (JP)

(72) Inventors: Hiroshi SEKIYA, Tokyo (JP); Hideaki MORI, Fuji-shi, Shizuoka (JP)

(21) Appl. No.: 15/569,718

(22) PCT Filed: Apr. 5, 2016
(86) PCT No.: PCT/JP2016/001918

§ 371 Date: Oct. 26, 2017

(30) Foreign Application Priority Data
Apr. 27, 2015 (JP) 2015-090883

(51) Int. Cl. B05B 13/04; B05B 15/65; D21F 7/00; D21H 23/50; D21H 21/02; D21H 21/20

(52) U.S. Cl. CPC B05B 13/041; B05B 15/65; D21H 21/20; D21H 23/50; D21H 21/02; D21F 7/00

(57) ABSTRACT

To provide an easily maintainable spraying apparatus.

The present invention is directed to a spraying apparatus 100 including: a nozzle device 1 including nozzle sections 1a and 1b for spraying a fluid; tubes 2a and 2b via which the fluid is supplied to the nozzle sections 1a and 1b; a cableveyor 3 whose hollow portion 3a accommodates the tubes 2a and 2b; a base 10 to which the nozzle device 1 is attached; a drive transmission section 11 to which the base 10 is attached; a drive section 12 that drives the drive transmission section 11; and a chassis 20 that accommodates the cableveyor 3 and the drive transmission section 11, wherein the drive transmission section 11 and the cableveyor 3 are provided next to each other so as not to vertically overlap each other, and the drive section 12 drives the drive transmission section 11 so that the nozzle device 1 moves via the base 10.

### TECHNICAL FIELD

The present invention relates to spraying apparatuses and, more specifically, to an easily maintainable spraying apparatus.

### BACKGROUND ART

In general, a paper making process in a paper-making machine includes: a wire part of forming wet paper by placing a water solution in which pulp has been dispersed on a paper-making net (wires) and letting excess water naturally drop; a press part of removing water from the wet paper by passing the wet paper through a pair of press rollers, pressing the wet paper with the press rollers via felt, and thereby causing moisture in the wet paper to migrate to the felt; a dry part of causing the wet paper having passed through the press part to form a paper body by becoming dry by making contact with a dryer roller while being pressed against a canvas; and a reel part of winding the paper body on a stick called “spool”.

In the paper making process, a chemical solution such as a wet strength agent, a cleaning agent, a pitch control agent, an anti-contamination agent, or a mold release agent is applied to a moving body such as the paper body, the wires, the felt, the dryer roller, the canvas, a canvas roller, or a calender roller during operation for the purpose, for example, of preventing adhesion of foreign matter derived from pulp row material or of improving releasability of the wet paper from the moving body.

Incidentally, a known spraying apparatus that applies a chemical solution is one that, in order to efficiently apply a chemical solution, sprays the chemical solution from a nozzle device while causing the nozzle device to reciprocate in a width direction of such a moving body.

For example, a spraying apparatus is known in which while a nozzle unit is being moved, a solid lubricant atomized by discharge pressure is sprayed onto a paper-making machine dryer surface through a spraying orifice of a spray unit moving within a spraying apparatus main body placed at 5 cm or more from a dryer surface (see, for example, PTL 1).

It should be noted that the spraying apparatus includes a chemical solution tank, an accessory device, a cableveyor, and a timing belt or a caterpillar chain.

### CITATION LIST

### Patent Literature

PTL 1: Japanese Patent Application Laid-Open No. 6-280181

### SUMMARY OF INVENTION

### Technical Problem

However, in the aforementioned spraying apparatus described in PTL 1, the vertically overlapped disposition of the cableveyor and the timing belt makes it impossible to visually check the status of the cableveyor from outside, thus making it necessary to remove the timing belt in maintaining the cableveyor.

The present invention has been made in view of the foregoing circumstances and has as an object to provide an easily maintainable spraying apparatus.

### Solution to Problems

The inventors of the present invention diligently studied in order to solve the problems described above. As a result, the inventors found that the problems can be solved by placing a drive transmission section and a cableveyor in such a positional relationship that they do not vertically overlap each other and fixing a second end of the cableveyor to an end of a bottom surface of a chassis. Thus, the inventors finally accomplished the present invention.

A first aspect of the present invention is directed to a spraying apparatus having an elongated shape, including: a nozzle device that sprays a fluid onto a moving body in a paper-making machine while reciprocating in a longitudinal direction, the nozzle device including a nozzle section for spraying the fluid; a tube via which the fluid is supplied to the nozzle section; a cableveyor whose hollow portion accommodates the tube; a base to which the nozzle device is attached; a drive transmission section to which the base is attached; a drive section that drives the drive transmission section; and a chassis that accommodates the cableveyor and the drive transmission section, wherein the drive transmission section and the cableveyor are provided next to each other so as not to vertically overlap each other, and the drive section drives the drive transmission section so that the nozzle device moves via the base.

A second aspect of the present invention is directed to the spraying apparatus according to the first aspect, wherein the cableveyor has its first end detachably attached to the base and its second end detachably fixed to an end of a bottom surface of the chassis.

A third aspect of the present invention is directed to the spraying apparatus according to the first or second aspect, wherein the drive transmission section is an endless metallic chain.

A fourth aspect of the present invention is directed to the spraying apparatus according to any one of the first to third aspects, wherein the base is detachable from the drive transmission section.

A fifth aspect of the present invention is directed to the spraying apparatus according to any one of the first to fourth aspects, wherein the drive section is a gear drive motor having an operating temperature limit of 80° C. or higher.

A sixth aspect of the present invention is directed to the spraying apparatus according to any one of the first to fifth aspects, wherein the tube has a space factor of 30% or larger on a cross-section of the hollow portion of the cableveyor.

A seventh aspect of the present invention is directed to the spraying apparatus according to any one of the first to sixth aspects, including a plurality of units each composed of the nozzle device, the base, the tube, and the cableveyor, wherein a plurality of the bases are attached to the drive transmission section at regular intervals, and a plurality of the cableveyors are placed in such a manner as to vertically overlap each other.

An eighth aspect of the present invention is directed to the spraying apparatus according to any one of the first to seventh aspects, wherein the fluid is a chemical solution or air.

A ninth aspect of the present invention is directed to a chemical solution that is applied by using the spraying apparatus according to any one of the first to seventh aspects, the chemical solution being a fluid that is sprayed by the spraying apparatus, the chemical solution being a wet strength agent, a cleaning agent, a pitch control agent, an anti-contamination agent, or a mold release agent.

A tenth aspect of the present invention is directed to the chemical solution according to the ninth aspect, wherein the chemical solution has a viscosity of 500 cps or lower.

### Advantageous Effects of Invention

In the spraying apparatus of the present invention, the drive transmission section and the cableveyor are provided next to each other so as not to vertically overlap each other. This makes it possible, without removing the drive transmission section, to check the amount of accumulated waste, the degree of deterioration, or the like by visually checking the status of the cableveyor from outside, thus making maintenance easy.

Further, providing the drive transmission section and the cableveyor next to each other allows the spraying apparatus per se to be made compact.

The spraying apparatus of the present invention makes it possible to detaching the cableveyor from the end of the chassis by detachably fixing the second end of the cableveyor to the end of the bottom surface of the chassis and, furthermore, to easily take out the cableveyor from the spraying apparatus by pulling in the cableveyor at that position.

In a case where the drive transmission section is an endless metallic chain, the spraying apparatus of the present invention makes it possible to smooth the reciprocation of the nozzle device with a simple device.

In a case where the base is detachable from the drive transmission section, the spraying apparatus of the present invention makes it easy to maintain the nozzle device, as the nozzle device is easily detachable from the drive transmission section.

In a case where the drive section is a gear drive motor having an operating temperature limit of 80° C. or higher, the spraying apparatus of the present invention makes it possible to achieve stable operation even in a site of work in hot environment.

In a case where the space factor of tubes on a cross-section of the hollow portion of the cableveyor is 30% or larger, the spraying apparatus of the present invention allows itself to be made compact. Further, there is an advantage in that none of the tubes will dance even in a case where the nozzle device has moved.

In the spraying apparatus of the present invention, in a case where the fluid is a chemical solution, application of the chemical solution to the moving body from the nozzle section of the nozzle device makes it possible to exhibit an effect based on the chemical solution. For example, in a case where the chemical solution is an anti-contamination agent, adhesion of foreign matter derived from pulp raw material can be prevented, and in a case where the chemical solution is a release agent, releasability of wet paper from the moving body can be improved. It should be noted that the nozzle device may further include a nozzle section that sprays air.

Meanwhile, in a case where the fluid is air, application of the air to the moving body from the nozzle section of the nozzle device makes it possible, for example, to remove clinging dust by blowing it off.

In a case where the spraying apparatus of the present invention includes a plurality of units each composed of the nozzle device, the base, the tube, and the cableveyor, a plurality of the cableveyors are placed in such a manner as to vertically overlap each other, so that the spraying apparatus per se can be made more compact.

Further, in maintaining the cableveyors, the plurality of cableveyors can be detached at once from the end of the chassis.

The chemical solution of the present invention, which is applied by using the aforementioned spraying apparatus and is a wet strength agent, a cleaning agent, a pitch control agent, an anti-contamination agent, or a mold release agent, can impart these functions to a moving body of a paper-making machine.

Note here that, from the point of view of spraying stability, it is preferable that the chemical solution have a viscosity of 500 cps or lower.

### BRIEF DESCRIPTION OF DRAWINGS

FIG. 1(a) is a top view showing an embodiment of a spraying apparatus according to the present invention, and FIG. 1(b) is a side view as taken along arrow A of FIG. 1(a).

FIG. 2 is an explanatory diagram showing a cross-section of the spraying apparatus shown in FIG. 1(a) as taken along line B-B.

FIG. 3 is an explanatory diagram showing a cross-section of the spraying apparatus shown in FIG. 1(a) as taken along line C-C.

FIG. 4 is an explanatory diagram for explaining a space factor on a cross-section of a cableveyor of the spraying apparatus according to the present embodiment.

FIG. 5(a) is a partial cross-sectional view of the spraying apparatus shown in FIG. 1(a) as taken along line D-D, and FIG. 5(b) is a partial cross-sectional view of the spraying apparatus shown in FIG. 1(a) as taken along line E-E.

### DESCRIPTION OF EMBODIMENTS

Preferred embodiments of the present invention are described in detail below with reference to the drawings as needed. In the drawings, the same components are given the same reference signs, and repetition of the same descriptions is omitted. Further, unless otherwise noted, positional relationships such as top and bottom, left and right are based on those shown in the drawings. Furthermore, the dimensional ratios of the drawings are not limited to those shown in the drawings.

First, an embodiment of a spraying apparatus according to the present invention is described.

A spraying apparatus according to the present embodiment is an apparatus having an elongated shape and including a nozzle device that sprays a chemical solution and air onto a moving body in a paper-making machine while reciprocating in a longitudinal direction.

Note here that examples of the moving body include a paper body, wires, felt, a dryer roller, a canvas, a canvas roller, a calender roller, and the like.

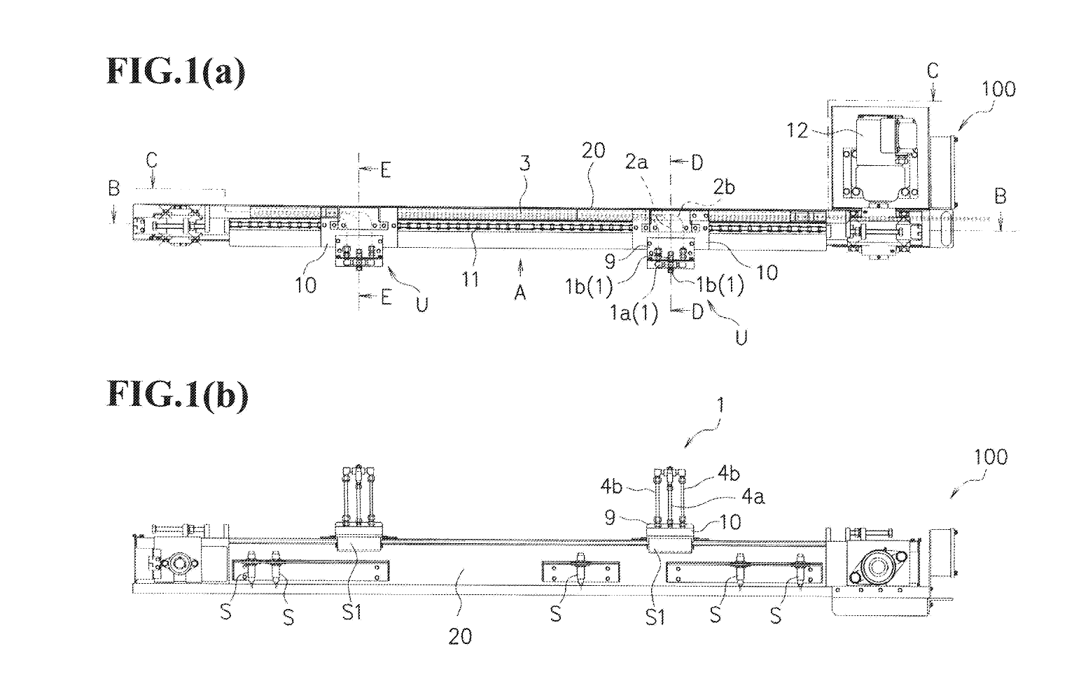

FIG. 1(a) is a top view showing an embodiment of a spraying apparatus according to the present invention, and FIG. 1(b) is a side view as taken along arrow A of FIG. 1(a).

As shown in FIG. 1(a), a spraying apparatus 100 according to the present embodiment includes a nozzle device 1 including a nozzle section (hereinafter referred to as “first nozzle section” for descriptive purposes) 1a for spraying a chemical solution and a nozzle section (hereinafter referred to as “second nozzle section” for descriptive purposes) 1b for spraying air, a tube (hereinafter referred to as “first tube” for descriptive purposes) 2a via which air is supplied to the first nozzle section 1a, tubes (hereinafter referred to as “second tubes” for descriptive purposes) 2b via which a chemical solution is supplied to the second nozzle section 1b, a cableveyor 3 whose hollow portion accommodates the first tube 2a and the second tube 2b, a base 10 to which the nozzle device 1 is attached, a drive transmission section 11 to which the base 10 is attached, a drive section 12 that drives the drive transmission section 11, and an elongated chassis 20 that accommodates the cableveyor 3 and the drive transmission section 11.

Further, the spraying apparatus 100) includes two units U each composed of a nozzle device 1, a base 10, a first tube 2a, second tubes 2b, and a cableveyor 3.

Moreover, the bases 10 of the adjacent units U are attached to the drive transmission section 11 at regular intervals. That is, the units U do not interfere with each other when the nozzle devices 1 reciprocate.

The spraying apparatus 100, which includes a plurality of units U, makes it possible to efficiently spray a chemical solution and air onto a moving body.

In the spraying apparatus 100, the drive transmission section 11 and the cableveyor 3 are provided next to each other and are placed within the chassis 20 in such a positional relationship as not to vertically overlap each other.

This makes it possible, without removing the drive transmission section 11, to check the amount of accumulated waste, the degree of deterioration, or the like by visually checking the status of the cableveyor 3 from outside, thus making maintenance easy.

Further, since the drive transmission section 11 and the cableveyor 3 are provided next to each other, the spraying apparatus 100 per se can be made more compact.

It should be noted that the drive transmission section 11 and the cableveyor 3 will be described in detail later.

In the spraying apparatus 100, the nozzle device 1 includes a first nozzle section 1a for spraying a chemical solution and a second nozzle section 1b for spraying air.

Note here that a pair of the second nozzle sections 1b are provided in front of and behind the first nozzle section 1a, respectively, so that a chemical solution that is sprayed from the first nozzle section 1a is sandwiched between air that is sprayed from the second nozzle sections 1b toward the front and back of the chemical solution.

In this way, the air that is sprayed toward the front and back of the chemical solution sprayed from the nozzle section 1a of the nozzle device 1 prevents the chemical solution from scattering in a cross direction.

As shown in FIG. 1(b), the nozzle device 1 has a connecting pipe (hereinafter referred to as “first connecting pipe” for descriptive purposes) 4a attached to substantially the center of a lower surface thereof and a pair of connecting pipes (hereinafter referred to as “second connecting pipes” for descriptive purposes) 4b attached to both side of the lower surface.

Moreover, the nozzle device 1 is supported by the pair of second connecting pipes.

The first connecting pipe 4a and the second connecting pipes 4b are attached to a connecting base 9, and the connecting base 9 is attached to the base 10.

That is, the nozzle device 1 is attached to the base 10 via the first connecting pipe 4a, the second connecting pipes 4b, and the connecting base 9.

Note here that a detected body S1 is attached to a lower surface of the connecting base 9.

Meanwhile, a plurality of proximity sensors S are provided in a longitudinal direction of the chassis 20 of the spraying apparatus 100.

Therefore, in the spraying apparatus 100, when the detected body S1 comes above the proximity sensors S, the proximity sensors S detect the detected body S1, so that it is possible to control how the nozzle device 1 reciprocates and where the nozzle device 1 stops.

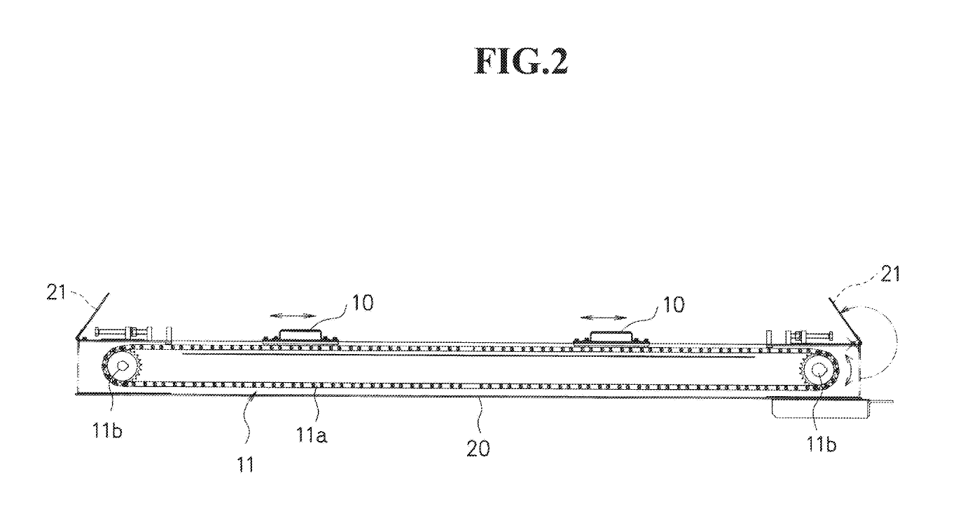

FIG. 2 is an explanatory diagram showing a cross-section of the spraying apparatus shown in FIG. 1(a) as taken along line B-B.

As shown in FIG. 2, the drive transmission section 11 is composed of an endless metallic chain. Specifically, the drive transmission section 11 includes a pair of toothed wheels 11b and an endless metallic chain 11a stretched on the toothed wheels 11b. This makes it possible to smooth the reciprocation of the nozzle device with a simple device.

Moreover, the aforementioned base 10 is attached to the metallic chain 11a of the drive transmission section 11.

The drive section 12 is attached to the toothed wheels 11b of the drive transmission section 11 (see FIG. 1(a)).

Therefore, in the spraying apparatus 100, the drive transmission section 11 is driven by the drive section 12. Specifically, a gear drive motor serving as the drive section 12 rotates the toothed wheels 11b so that the metallic chain 11a moves and the nozzle device 1 moves via the base 10 attached to the metallic chain 11a.

It should be noted that it is preferable that the gear drive motor have an operating temperature limit of 80° C. or higher. In this case, stable operation can be achieved even in a site of work in hot environment.

In the spraying apparatus 100, the base 10 is detachable from the drive transmission section 11. For this reason, the spraying apparatus 100, from which the nozzle device 1 can be easily detached by detaching the base 10 from the drive transmission section 11, has an advantage in that the nozzle device 1 is easily maintained.

The drive transmission section 11 is accommodated in the chassis 20.

The chassis 20 is in the shape of a rectangular parallelepiped. It should be noted that the chassis 20 may alternatively have a rectangular shape or a partially truncated U or C shape in cross-section.

Note here that the chassis 20 has its right and left side surfaces serving as openable and closable lids 21.

This makes it possible to take out the drive transmission section 11 through the lids 21 in performing maintenance on the drive transmission section 11. It should be noted that in a case where the annular drive transmission section 11 is taken out, it can be easily taken out through the lids 21 by cutting a part thereof.

With continued reference to FIGS. 1(a) and 1(b), the spraying apparatus 100 has a tube (hereinafter referred to as “first tube” for descriptive purposes) 2a attached to the tip of the first connecting pipe 4a and tubes (hereinafter referred to as “second tubes” for descriptive purposes) 2b attached to the tips of the pair of second connecting pipes 4b, respectively.

These tubes may be made of any material. However, from the point of view of durability, it is preferable that these tubes be made of fluororesin.

Moreover, the air is supplied from an air supply device (not illustrated) to the second nozzle sections 1b by flowing through the first tube 2a and the first connecting pipe 4a in sequence.

Further, the chemical solution is supplied from a chemical solution tank (not illustrated) to the first nozzle section 1a by flowing through the second tubes 2b and the second connecting pipes 4b in sequence.

In the spraying apparatus 100, the first tube 2a and the second tubes 2b are accommodated in the hollow portion of the cableveyor 3. This allows the first tube 2a and the second tubes 2b to be protected when the nozzle device 1 reciprocates. That is, the first tube 2a and the second tubes 2b are prevented from being damaged in friction with another component when the nozzle device 1 reciprocates.

In the spraying apparatus 100, the cableveyor 3 is a bendable long chain including a plurality of small ringed pieces that are joined together.

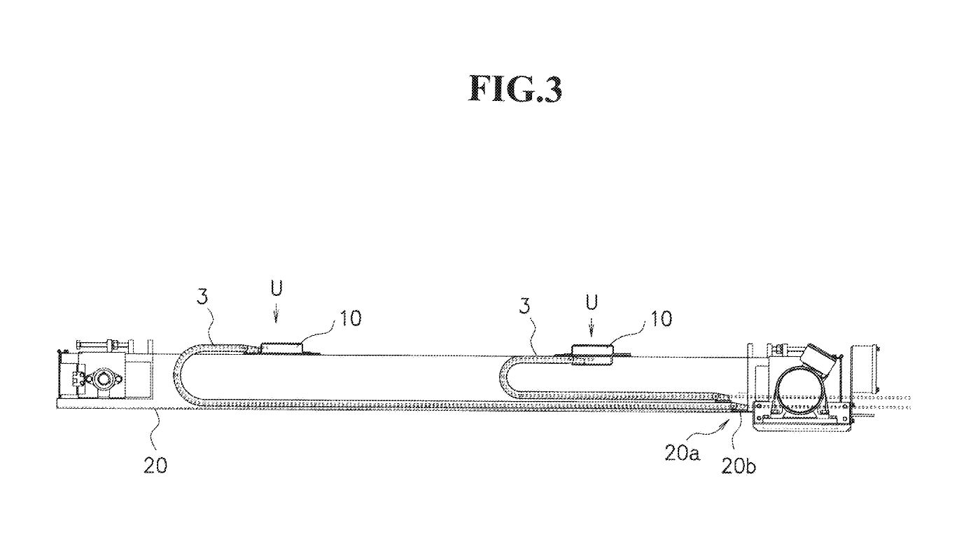

FIG. 3 is an explanatory diagram showing a cross-section of the spraying apparatus shown in FIG. 1(a) as taken along line C-C.

As shown in FIG. 3, in the spraying apparatus 100, the cableveyor 3 has its first end detachably attached to the base 10 and its second end detachably fixed to an end 20a of a bottom surface of the chassis 20. This allows the cableveyor 3 to bend as the nozzle device 1 reciprocates.

The spraying apparatus 100 makes it possible to, in maintaining the cableveyor 3, easily take out only the cableveyor 3 from the spraying apparatus 100 without removing a peripheral device such the nozzle device 1. This is achieved by detaching the second end of the cableveyor 3 from the end 20a of the chassis 20, pulling in the cableveyor 3 at that position, detaching the first end of the cableveyor 3 from the base 10, which has come to the near side.

Note here that an openable and closable slot 20b be provided at the end 20a of the bottom surface of the chassis 20.

In the spraying apparatus 100, the cableveyors 3 of the adjacent units U are placed within the chassis 20 in such a state as to vertically overlap each other. This allows the spraying apparatus 100 per se to be made compact.

Further, in maintaining the plurality of cableveyors 3, all of the cableveyors can be detached at once from the end 20a of the chassis 20.

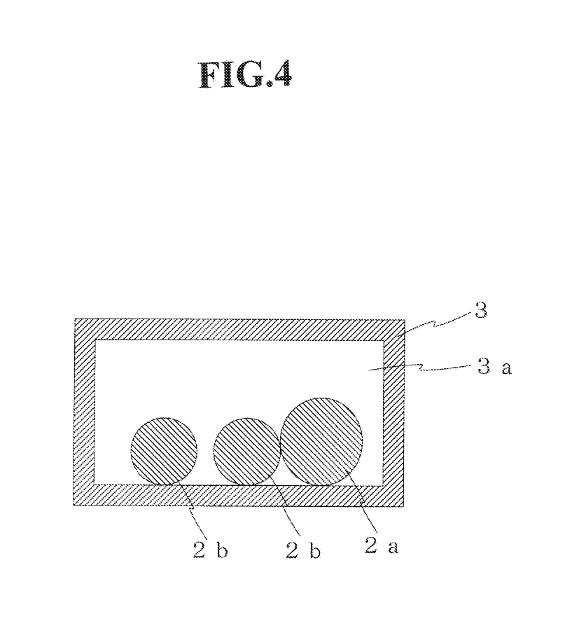

FIG. 4 is an explanatory diagram for explaining a space factor on a cross-section of a cableveyor of the spraying apparatus according to the present embodiment. It should be noted that although the tubes are hollow, they are shown in cylindrical cross-section for descriptive purposes.

As shown in FIG. 4, in the cableveyor 3, as mentioned above, the first tube 2a and the two second tubes 2b are accommodated in the hollow portion 3a.

Note here that it is preferable that the space factor (SB×100/SA) of the sum SB (SB=S1+S2+S2) of the cross-sectional area of the first tube 2a and the cross-sectional areas of the two second tubes 2b with respect to the cross-sectional area SA of the hollow portion 3a of the cableveyor 3 be 30% or larger.

When the space factor of all of the tubes on the cross-section of the hollow portion 3a is 30% or larger, the cableveyor 3 can be made more compact in size. Further, there is an advantage in that none of the tubes will dance even in a case where the nozzle device has moved.

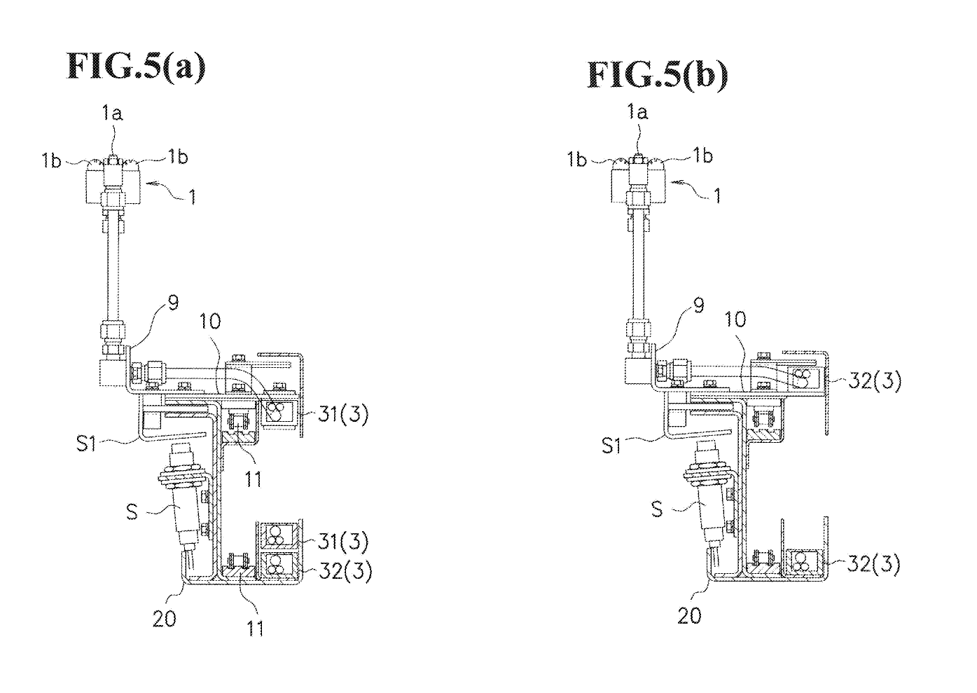

FIG. 5(a) is a partial cross-sectional view of the spraying apparatus shown in FIG. 1(a) as taken along line D-D. and FIG. 5(b) is a partial cross-sectional view of the spraying apparatus shown in FIG. 1(a) as taken along line E-E.

As shown in FIGS. 5(a) and 5(b), the drive transmission section 11 and the cableveyor 3, which are accommodated in the chassis 20, is provided next to each other as mentioned above.

Note here that there is a wall between the drive transmission section 11 and the cableveyor 3 so that they are placed in different compartments from each other.

This makes it possible to prevent the drive transmission section 11 and the cableveyor 3 from interfering with each other when the nozzle device reciprocates.

Further, the cableveyors 3 of the adjacent units U are placed at different heightwise positions from each other.

That is, as compared with the heightwise position of a cableveyor 31 of a first unit U shown in FIG. 5(a), the heightwise position of a cableveyor 32 of a second unit U shown in FIG. 5(b) has its upper side located in a higher position and its lower side located in a lower position.

This makes it possible to restraint the cableveyors 3 from interfering with each other even if the distance between the nozzle devices 1 of the adjacent units U is short.

The spraying apparatus 100 according to the present embodiment is placed so that its longitudinal direction is parallel to a width direction of the moving body.

Moreover, the nozzle device 1 of the spraying apparatus 100 sprays a chemical solution and air onto the moving body while reciprocating in the longitudinal direction.

Next, an embodiment of a chemical solution according to the present invention is described.

A chemical solution according to the present embodiment is applied by using the aforementioned spraying apparatus 100.

An example of the chemical solution is a wet strength agent, a cleaning agent, a pitch control agent, an anti-contamination agent, a mold release agent, or the like.

Since the spraying apparatus 100 can surely apply the chemical solution to the moving body, the moving body to which the chemical solution has been applied can surely exhibit a function based on the chemical solution applied thereto. For example, in a case where the chemical solution is an anti-contamination agent, adhesion of foreign matter derived from pulp raw material can be prevented, and in a case where the chemical solution is a release agent, releasability of wet paper from the apparatus can be improved.

It should be noted that it is preferable that the chemical solution have a viscosity of 500 cps or lower, more preferably 1 to 200 cps. In this case, the chemical solution can be surely applied to the moving body, and scattering of the chemical solution can be sufficiently restrained.

Although a preferred embodiment of the present invention has been described above, the present invention is not limited to the embodiment described above.

The spraying apparatus 100 according to the present embodiment includes a nozzle device 1 that sprays a chemical solution and air onto a moving body in a paper-making machine while reciprocating in a longitudinal direction, the nozzle device is not limited to this structure.

For example, the nozzle device may be one that sprays only a chemical solution to a moving body or may be one that sprays only air.

In a case where the nozzle device is one that sprays only a chemical solution, application of a chemical solution to a moving body makes it possible to exhibit an effect based on the chemical solution.

Further, in a case where the nozzle device is one that sprays only air, application of air to a moving body makes it possible, for example, to remove clinging dust by blowing it off.

It should be noted that, in these cases, the nozzle device needs only have one nozzle section, and the number of tubes via which a chemical solution or air is supplied needs only be 1. Further, the number of tubes that are accommodated in a cableveyor 3 is 1, too.

While the spraying apparatus 100 according to the present embodiment includes two units U each composed of a nozzle device 1, a base 10, a first tube 2a, second tubes 2b, and a cableveyor 3, the spraying apparatus may be one including only one unit U or may be one including three or more units U.

It should be noted that even in a case where the spraying apparatus includes three or more units U, the cableveyors 3 are placed in such a manner as to vertically overlap each other.

In the spraying apparatus 100 according to the present embodiment, the nozzle device 1 is supported by the first connecting pipe 4a and the second connecting pipes 4b. However, it is not always necessary to provide a connecting pipe.

Further, although the first connecting pipe 4a and the second connecting pipes 4b are attached to the connecting base 9. However, it is not always necessary to provide the connecting base 9.

That is, the nozzle device may be directly attached to the base 10.

In the spraying apparatus 100 according to the present embodiment, the proximity sensors S are attached to the lower surface of the connecting base 9. However, instead of the proximity sensors S, limit switches, tactile switches, or the like may be attached.

In the spraying apparatus 100 according to the present embodiment, the connecting base 9 is attached to the base 10, and it is preferable that the connecting base 9 be detachable from the base 10.

In this case, maintenance of the detected body S1 provided on the connecting base 9 can be easily performed by detaching the connecting base 9 from the base 10.

In the spraying apparatus 100 according to the present embodiment, the drive transmission section 11 includes a pair of toothed wheels 11b and an endless metallic chain 11a stretched on the toothed wheels 11b. Instead of doing so, the drive transmission section 11 may include a timing belt, a wire, a rack, a gear, a cam, and the like.

In the spraying apparatus 100 according to the present embodiment, the drive section 12 is a gear drive motor. However, instead of being a gear drive motor, the drive section 12 may be a cylinder, a linear motor, or the like.

### INDUSTRIAL APPLICABILITY

A spraying apparatus of the present invention is suitably used as an apparatus for applying a fluid to a moving body in a paper-making machine. The spraying apparatus of the present invention has an advantage that it is easily maintainable.

### REFERENCE SIGNS LIST

1 . . . Nozzle device
1a . . . First nozzle section (nozzle section)
1b . . . Second nozzle section (nozzle section)
10 . . . Base
100 . . . Spraying apparatus
11 . . . Drive transmission section
11a . . . Metallic chain
11b . . . Toothed wheel
12 . . . Drive section
2a . . . First tube (tube)
2b . . . Second tube (tube)
20 . . . Chassis
20a . . . End
20b . . . Slot
21 . . . Lid
3, 31, 32 . . . Cableveyor (registered trademark)
3a . . . Hollow portion
4a . . . First connecting pipe (connecting pipe)
4b . . . Second connecting pipe (connecting pipe)
9 . . . Connecting base
S . . . Proximity sensor
S1 . . . Detected body
U . . . Unit

1. A spraying apparatus having an elongated shape, comprising:
a nozzle device that sprays a fluid onto a moving body in a paper-making machine while reciprocating in a longitudinal direction, the nozzle device including a nozzle section for spraying the fluid;
a tube via which the fluid is supplied to the nozzle section;
a cableveyor whose hollow portion accommodates the tube;
a base to which the nozzle device is attached;
a drive transmission section to which the base is attached;
a drive section that drives the drive transmission section; and
a chassis that accommodates the cableveyor and the drive transmission section,
wherein the drive transmission section and the cableveyor are provided next to each other so as not to vertically overlap each other, and
the drive section drives the drive transmission section so that the nozzle device moves via the base.

2. The spraying apparatus according to claim 1, wherein the cableveyor has its first end detachably attached to the base and its second end detachably fixed to an end of a bottom surface of the chassis.

3. The spraying apparatus according to claim 1, wherein the drive transmission section is an endless metallic chain.

4. The spraying apparatus according to claim 1, wherein the base is detachable from the drive transmission section.

5. The spraying apparatus according to claim 1, wherein the drive section is a gear drive motor having an operating temperature limit of 80° C. or higher.

6. The spraying apparatus according to claim 1, wherein the tube has a space factor of 30% or larger on a cross-section of the hollow portion of the cableveyor.

7. The spraying apparatus according to claim 1, comprising a plurality of units each composed of the nozzle device, the base, the tube, and the cableveyor,
wherein a plurality of the bases are attached to the drive transmission section at regular intervals, and
a plurality of the cableveyors are placed in such a manner as to vertically overlap each other.

8. The spraying apparatus according to claim 1, wherein the fluid is a chemical solution or air.

9. A chemical solution that is applied by using the spraying apparatus according to claim 1,
the chemical solution being a fluid that is sprayed by the spraying apparatus,
the chemical solution being a wet strength agent, a cleaning agent, a pitch control agent, an anti-contamination agent, or a mold release agent.

10. The chemical solution according to claim 9, wherein the chemical solution has a viscosity of 500 cps or lower.
